(19) United States
(12) Patent Application Publication
(10) Pub. No.: US 2023/0356510 A1
(43) Pub. Date: Nov. 9, 2023

(54) PACKAGING ARTICLE FILM HAVING RECLAIMED CONTENT

(71) Applicant: Sealed Air Corporation (US), Charlotte, NC (US)

(72) Inventors: Janet Rivett, Charlotte, NC (US); Drew V. Speer, Charlotte, NC (US)

(21) Appl. No.: 17/802,212

(22) PCT Filed: Feb. 25, 2021
(86) PCT No.: PCT/US2021/019560

§ 371 Date: Aug. 25, 2022

Related U.S. Application Data
(60) Provisional application No. 62/981,703, filed on Feb. 26, 2020.

(51) Int. Cl. B32B 27/08; B32B 27/32; B32B 27/18; B32B 27/30; B32B 27/34; B65B 5/04; B65B 5/02; B65D 65/40; B32B 7/12

(52) U.S. Cl. CPC B32B 27/08; B32B 27/32; B32B 27/18; B32B 27/306; B32B 27/34; B32B 27/308; B65B 5/045; B65B 5/022; B65D 65/40; B32B 7/12; B32B 2307/31; B32B 2272/00; B32B 2270/00; B32B 2307/306; B32B 2307/72; B32B 2307/744; B32B 2250/24; B32B 2307/54; B32B 2307/5825; B32B 2307/558; B32B 2307/7244; B32B 2307/414; B32B 2439/46; B32B 2439/70; B32B 2307/7376

(57) ABSTRACT

A multi-layer film, a packaging article and a method of manufacture a packaging article from the multi-layer film is disclosed. The multi-layer film having at least 25% scrap material content, a compatibilizer and antioxidant and being useful for the packaging of food products. The scrap material including a blend of polymers reclaimed from streams of waste and recycling.

### BACKGROUND

The subject matter disclosed herein relates to the field of packaging article film. More particularly to food packaging article films suited for packaging food.

Food packaging article films typically used for packaging food to protect the food item from the environment and to extend shelf life. Food packaging articles such as bags are often used to hold bakery products, such as breads, bagels, scones, muffins and the like. Food packaging bags include a subset of reclosable bags for easy access to items such as cheeses, deli meats and snack items.

Utilizing a recycle stream of polymers can divert these materials from the landfill to useful products while also reducing the demand for virgin materials. Unfortunately, most recycle streams of polymers include a number of impurities or additional components that make it difficult to use in a polyolefin containing material. Furthermore, recycling polymers can result in altering the physical properties, shortening polymer chains and lead to thermal degradation of the polymer. Many recycle streams contain scrap materials and mixtures of materials that cannot be easily reused since the impurities, including but not limited to polyamide, ethylene vinyl alcohol, polypropylene, polyester, act as heat resistant materials and generally do not melt and flow at the similar low temperatures as other polyolefin resins (such a polyethylene). This makes processability difficult and introduces additional challenges to utilizing recycle streams.

To avoid these issues, many recycle streams will attempt to eliminate or greatly reduce the amount of impurities and other material that prohibits melt and flow. For example, by limiting heat resistant materials concentration to very low levels, the material may still flow at reasonable temperatures.

Therefore, the ability to use a polymer recycle stream to manufacture packaging articles without greatly reducing the amount of heat resistant materials is desirable.

The discussion above is merely provided for general background information and is not intended to be used as an aid in determining the scope of the claimed subject matter.

### BRIEF DESCRIPTION

A multi-layer film, a packaging article and a method of manufacture a packaging article from the multi-layer film is disclosed. The multi-layer film having at least 25% scrap material content, a compatibilizer and antioxidant and being useful for the packaging of food products. The scrap material including a blend of polymers reclaimed from streams of waste and recycling.

An advantage that may be realized in the practice of some disclosed embodiments of the film is the use of scrap material included in a useful article.

In one exemplary embodiment, a multi-layer film is disclosed. The multi-layer film comprises at least one heat seal layer having a seal initiation temperature of less than any of the following temperatures: 220° C., 210° C., 200° C., 190° C., 180° C., 170° C., 160° C., 150° C., 140° C. or 130° C.; and at least one reclaim layer. The at least one heat seal layer having a calculated composite melt index of at least 3.0, 2.0 or 1.0 g/10 min @190° C. and 2.16 kg measured in accordance with ASTM D1238. The reclaim layer comprising: a) a blend of a polyolefin and at least one heat resistant polymer selected from the group consisting of polyamide, ethylene vinyl alcohol, polypropylene, polyester, and blends thereof; b) the at least one heat resistant polymer comprising at least 7.0, 7.5, 8.0, 8.5, 9.0, 9.5 or 10 wt % the total weight of the reclaim layer; c) at least 0.5 wt % of a compatibilizer; d) at least 0.05 wt % of an antioxidant; e) the at least one reclaim layer having a calculated composite melt index of less than 1.0, or 0.5 g/10 min @190° C. and 2.16 kg measured in accordance with ASTM D1238. The multi-layer film structure has a total scrap content of at least 25 wt % based on the total weight of the multi-layer film.

In another exemplary embodiment, the multi-layer film forms a packaging article comprising a first multi-layer film structure. The multi-layer film comprises at least one heat seal layer having a seal initiation temperature of less than any of the following temperatures: 220° C., 210° C., 200° C., 190° C., 180° C., 170° C., 160° C., 150° C., 140° C. or 130° C.; and at least one reclaim layer. The at least one heat seal layer having a calculated composite melt index of at least 3.0, 2.0 or 1.0 g/10 min @190° C. and 2.16 kg measured in accordance with ASTM D1238. The reclaim layer comprising: a) a blend of a polyolefin and at least one heat resistant polymer selected from the group consisting of polyamide, ethylene vinyl alcohol, polypropylene, polyester, and blends thereof; b) the at least one heat resistant polymer comprising at least 7.0, 7.5, 8.0, 8.5, 9.0, 9.5 or 10 wt % the total weight of the reclaim layer; c) at least 0.5 wt % of a compatibilizer; d) at least 0.05 wt % of an antioxidant; e) the at least one reclaim layer having a calculated composite melt index of less than 1.0, or 0.5 g/10 min @190° C. and 2.16 kg measured in accordance with ASTM D1238. The multi-layer film structure has a total scrap content of at least 25 wt %. The heat seal layer of the first multi-layer film being bond to the heat seal layer of the second multi-layer film.

In another exemplary embodiment, a method of making a packaging article is disclosed. The method comprises the steps of a) providing a multilayer film; b) bonding the multilayer film to itself or a second film; c) forming a packaging article according; d) filing the packaging article with a food product; and e) sealing the packaging article to seal the food product within the bonded multilayer film(s). The multi-layer film structure comprising: at least one heat seal layer having a seal initiation temperature of less than any of the following temperatures: 220° C., 210° C., 200° C., 190° C., 180° C., 170° C., 160° C., 150° C., 140° C. or 130° C. The at least one heat seal layer having a calculated composite melt index of at least 3.0, 2.0 or 1.0 g/10 min @190° C. and 2.16 kg measured in accordance with ASTM D1238. At least one reclaim layer comprising a blend of a polyolefin and at least one heat resistant polymer selected from the group consisting of polyamide, ethylene vinyl alcohol, polypropylene, polyester, and blends thereof. The at least one reclaim layer having a calculated composite melt index of less than 1.0, or 0.5 g/10 min @190° C. and 2.16 kg measured in accordance with ASTM D1238. The at least one heat resistant polymer comprising at least 7.0, 7.5, 8.0, 8.5, 9.0, 9.5 or 10 wt % the total weight of the reclaim layer. At least 0.5 wt % of a compatibilizer and at least 0.05 wt % of an antioxidant in the reclaim layer. The multi-layer film structure has a total scrap content of at least 25 wt %.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic view of a process for making a multilayer film;

FIG. 2 is a schematic of a hot blown film process for making films;

FIG. 3 illustrates a lay-flat view of a bag in accordance with an embodiment;

FIG. 4 illustrates a packaged product in accordance with an embodiment;

FIG. 5 illustrates a perspective view of a packaged product in accordance with an embodiment;

FIG. 6 illustrates a cross-sectional view through line 5-5 of the packaged product illustrated in FIG. 5;

FIG. 7 illustrates a cross-sectional view through line 5-5 of the packaged product illustrated in FIG. 5;

FIG. 8 illustrates a cross-sectional view through line 5-5 of the packaged product illustrated in FIG. 5;

FIG. 9 illustrates a perspective view of a packaged product;

FIG. 10 illustrates a schematic view of a end-seal bag in a lay-flat view;

FIG. 11 illustrates a schematic view of a side-seal bag in a lay-flat view; and

FIG. 12 illustrates a schematic view of a pouch in a lay-flat view.

### DETAILED DESCRIPTION

As used herein, the term “film” is inclusive of plastic web, regardless of whether it is film or sheet. The film can have a thickness of 0.25 mm or less, or a thickness of from 0.35 to 30 mils, or from 0.5 to 25 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

The multi-layer films described herein include at least one heat seal layer to allow the film to be sealed to itself or another film. The films further include at least one reclaim layer which imparts reclaim content into the multi-layer film. The films may further include additional layers, for example to add bulk, provide functionality, abuse resistance, barrier, printing capability or to act as a tie layer.

The multi-layer films described herein may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In embodiments, the multilayer film utilizes microlayers. A microlayer section may include between 10 and 1,000 microlayers in each microlayer section.

Below are some examples of combinations in which the alphabetical symbols designate the film layers. Where the multilayer film representation below includes the same letter more than once, each occurrence of the letter may represent the same composition or a different composition within the class that performs a similar function.

A/B, A/B/A, A/C/B, A/B/D, A/D/B, A/C/D, A/B/D/A, A/C/D/B, A/D/C/B, A/C/B/D, A/B/C/D, A/C/B/A, A/B/C/A, A/C/B/C/A, A/C/D/C/B, A/D/B/C/A, A/C/B/D/A, A/C/D/B/C/A, A/C/D/B/D/C/A, A/C/B/B/A, A/C/B/B/C/A, A/C/B/D/B/C/A

“A” represents a heat seal layer, as discussed herein.

“B” represents a reclaim layer, as discussed herein.

“C” represents an intermediate layer (e.g., a tie layer), as discussed herein.

“D” represents one or more other layers of the film, such as a bulk layer.

All compositional percentages used herein are presented on a “by weight” basis, unless designated otherwise.

As used herein, the phrases “seal layer”, “sealing layer”, “heat seal layer”, and “sealant layer”, refer to an outer layer, or layers, involved in the sealing of the film to itself, another layer of the same or another film, and/or another article which is not a film.

As used herein, the term “heat-seal,” and the phrase “heat-sealing,” refer to any seal of a first region of a film surface to a second region of a film surface, wherein the seal is formed by heating the regions to at least their respective seal initiation temperatures. Heat-sealing is the process of joining two or more thermoplastic films or sheets by heating areas in contact with each other to the temperature at which fusion occurs, usually aided by pressure. The heating can be performed by any one or more of a wide variety of manners, such as using a heated bar, hot wire, hot air, infrared radiation, ultraviolet radiation, electron beam, ultrasonic, and melt-bead. A heat seal is usually a relatively narrow seal (e.g., 0.02 inch to 1 inch wide) across a film. One particular heat sealing means is a heat seal made using an impulse sealer, which uses a combination of heat and pressure to form the seal, with the heating means providing a brief pulse of heat while pressure is being applied to the film by a seal bar or seal wire, followed by rapid cooling of the bar or wire.

Seal initiation temperature is the temperature to which the polymer must be heated before it will undergo useful bonding to itself under pressure. Therefore, heat sealing temperatures above the seal initiation temperature result in heat seals with considerable and measurable seal strength. Seal initiation temperature as used herein refers to a seal having a seal strength of at least 22.6 N/cm when sealed with a dwell time of about one second and a sealing pressure of 50 N/cm². After aging for at least 24 hours at 23° C. the seal strength is determined based on ASTM method D882. Sealed samples are cut into 25.4 mm wide pieces and then strength tested using a Zwick tensile meter at a strain rate of 500 mm/min and a 50 mm jaw separation. The free ends of the sample are fixed in jaws, and then the jaws are separated at the strain rate until the seal fails. The peak load at seal break is measured and the seal strength is calculated by dividing the peak load by the sample width.

Heat seal layers include thermoplastic polymers, including, but not limited to thermoplastic polyolefins, ethylene acrylic acid, ethylene methacrylic acid, and their ionomers. In embodiments, polymers for the sealant layer include homogeneous ethylene/alpha-olefin copolymer, heterogeneous ethylene/alpha-olefin copolymer, ethylene homopolymer, ethylene copolymer, and ethylene/vinyl acetate copolymer. In some embodiments, the heat seal layer can comprise a polyolefin, particularly an ethylene/alpha-olefin copolymer. For example, a polyolefin having a density of from 0.88 g/cc to 0.917 g/cc, or from 0.90 g/cc to 0.92 g/cc, or less than 0.95 g/cc. More particularly, the seal layer can comprise at least one member selected from the group consisting of linear low density, medium density polyethylene, low density polyethylene, very low density polyethylene, homogeneous ethylene/alpha-olefin copolymer, and polypropylene. “Polymer” herein refers to homopolymer, copolymer, terpolymer, etc. “Copolymer” herein includes copolymer, terpolymer, etc.

As used herein, the term “polyolefin” refers to olefin polymers and copolymers, especially ethylene and propylene polymers and copolymers, and to polymeric materials having at least one olefinic comonomer. Polyolefins can be linear, branched, cyclic, aliphatic, aromatic, substituted, or unsubstituted. Included in the term polyolefin are homopolymers of olefin, copolymers of olefin, copolymers of an olefin and a non-olefinic comonomer copolymerizable with the olefin, such as vinyl monomers, acrylics, modified polymers of the foregoing, and the like. Modified polyolefins include modified polymers prepared by copolymerizing or grafting the homopolymer of the olefin or copolymer thereof with an unsaturated carboxylic acid, e.g., maleic acid, fumaric acid or the like, or a derivative thereof such as the anhydride, ester metal salt of the carboxylic acid or the like. It could also be obtained by incorporating into the olefin homopolymer or copolymer, an unsaturated carboxylic acid, e.g., maleic acid, fumaric acid or the like, or a derivative thereof such as the anhydride, ester metal salt of the carboxylic acid or the like. In an embodiment, the heat seal layer is mainly composed of polyolefin. In an embodiment, the heat seal layer has a total polyolefin content of from 90 to 99 wt % based on the total composition of the heat seal layer.

Ethylene homopolymer or copolymer refers to ethylene homopolymer such as low density polyethylene, medium density polyethylene, high density polyethylene; ethylene/alpha olefin copolymer such as those defined hereinbelow; and other ethylene copolymers such as ethylene/vinyl acetate copolymer; ethylene/alkyl acrylate copolymer; or ethylene/(meth)acrylic acid copolymer. Ethylene/alpha-olefin copolymer herein refers to copolymers of ethylene with one or more comonomers selected from C4 to C10 alpha-olefins such as butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to ethylene/alpha-olefin copolymers and which high pressure polyethylenes contain both long chain and short chain branches. Ethylene/alpha-olefin copolymers include one or more of the following: 1) high density polyethylene, for example having a density greater than 0.94 g/cm³, 2) medium density polyethylene, for example having a density of from 0.93 to 0.94 g/cm³, 3) linear medium density polyethylene, for example having a density of from 0.926 to 0.94 g g/cm³, 4) low density polyethylene, for example having a density of from 0.915 to 0.939 g/cm³, 5) linear low density polyethylene, for example having a density of from 0.915 to 0.935 g/cm³, 6) very-low or ultra-low density polyethylene, for example having density below 0.915 g/cm³, and homogeneous ethylene/alpha-olefin copolymers. Homogeneous ethylene/alpha-olefin copolymers include those having a density of less than about any of the following: 0.925, 0.922, 0.92, 0.917, 0.915, 0.912, 0.91, 0.907, 0.905, 0.903, 0.90, and 0.86 g/cm³. Unless otherwise indicated, all densities herein are measured according to ASTM D1505.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. “Polyamide” specifically includes those aliphatic polyamides or copolyamides commonly referred to as e.g. polyamide 6 (homopolymer based on ε-caprolactam), polyamide 69 (homopolycondensate based on hexamethylene diamine and azelaic acid), polyamide 610 (homopolycondensate based on hexamethylene diamine and sebacic acid), polyamide 612 (homopolycondensate based on hexamethylene diamine and dodecandioic acid), polyamide 11 (homopolymer based on 11-aminoundecanoic acid), polyamide 12 (homopolymer based on ω-aminododecanoic acid or on laurolactam), polyamide 6/12 (polyamide copolymer based on ε-caprolactam and laurolactam), polyamide 6/66 (polyamide copolymer based on ε-caprolactam and hexamethylenediamine and adipic acid), polyamide 66/610 (polyamide copolymers based on hexamethylenediamine, adipic acid and sebacic acid), modifications thereof and blends thereof. Polyamide also includes crystalline or partially crystalline, amorphous (6I/6T), aromatic or partially aromatic, polyamides.

As used herein, “Polyesters” includes polymers made by: 1) condensation of polyfunctional carboxylic acids with polyfunctional alcohols, 2) polycondensation of hydroxycarboxylic acid, and 3) polymerization of cyclic esters (e.g., lactone).

Exemplary polyfunctional carboxylic acids (which includes their derivatives such as anhydrides or simple esters like methyl esters) include aromatic dicarboxylic acids and derivatives (e.g., terephthalic acid, isophthalic acid, dimethyl terephthalate, dimethyl isophthalate, naphthalene-2,6-dicarboxylic acid;) and aliphatic dicarboxylic acids and derivatives (e.g., adipic acid, azelaic acid, sebacic acid, oxalic acid, succinic acid, glutaric acid, dodecanoic diacid, 1,4-cyclohexane dicarboxylic acid, dimethyl-1,4-cyclohexane dicarboxylate ester, dimethyl adipate). Representative dicarboxylic acids may be represented by the general formula:

HOOC-Z-COOH

where Z is representative of a divalent aliphatic radical containing at least 2 carbon atoms. Representative examples include adipic acid, sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid (“I”) and terephthalic acid (“T”). As is known to those of skill in the art, polyesters may be produced using anhydrides and esters of polyfunctional carboxylic acids.

Exemplary polyfunctional alcohols include dihydric alcohols (and bisphenols) such as ethylene glycol, 1,2-propanediol, 1,3-propanediol, 1,3 butanediol, 1,4-butanediol, 1,4-cyclohexanedimethanol, 2,2-dimethyl-1,3-propanediol, 1,6-hexanediol, poly(tetrahydroxy-1,1′-biphenyl, 1,4-hydroquinone, bisphenol A, and cyclohexane dimethanol (“CHDM”).

Exemplary hydroxycarboxylic acids and lactones include 4-hydroxybenzoic acid, 6-hydroxy-2-naphthoic acid, pivalolactone, and caprolactone.

Exemplary polyesters may be derived from lactone polymerization; these include, for example, polycaprolactone and polylactic acid.

The polyester may comprise or be modified polyester. Exemplary modified polyester includes glycol-modified polyester and acid-modified polyester. Modified polyesters are made by polymerization with more than one type of comonomer in order to disrupt the crystallinity and thus render the resulting polyester more amorphous.

A glycol-modified polyester is a polyester derived by the condensation of at least one polyfunctional carboxylic acid with at least two types of polyfunctional alcohols. For example, glycol-modified poly(ethylene terephthalate) or “PETG” may be made by condensing terephthalic acid with ethylene glycol and cyclohexane dimethanol (“CHDM”). A useful PETG is available from Eastman Corporation under the Eastar 6763 trade name, and is believed to have about 34 mole % CHDM monomer content, about 16 mole % ethylene glycol monomer content, and about 50 mole % terephthalic acid monomer content. Another useful glycol-modified polyester may be made similar to PETG, but substituting dimethyl terephthalate for the terephthalic acid component. Another exemplary glycol-modified polyester is available under the Ecdel 9965 trade name from Eastman Corporation, and is believed to have a density of 1.13 g/cc and a melting point of 195° C. and to be derived from dimethyl 1,4 cyclohexane-dicarboxylate, 1,4 cyclohexane-dimethanol, and poly (tetramethylene ether glycol).

Exemplary acid-modified polyester may be made by condensation of at least one polyfunctional alcohol with at least two types of polyfunctional carboxylic acids. For example, at least one of the polyfunctional alcohols listed above may be condensed with two or more of the polyfunctional carboxylic acids listed above (e.g., isophthalate acid, adipic acid, and/or Naphthalene-2,6-dicarboxylic acid). An exemplary acid-modified polyester may be derived from about 5 mole % isophthalic acid, about 45 mole % terephthalic acid, and about 50 mole % ethylene glycol, such as that available from Invista Corporation.

The polyester may be selected from random polymerized polyester or block polymerized polyester.

The polyester may be derived from one or more of any of the constituents discussed above. If the polyester includes a mer unit derived from terephthalic acid, then such mer content (mole %) of the diacid of the polyester may be at least about any the following: 70, 75, 80, 85, 90, and 95%.

The polyester may be thermoplastic. The polyester may be substantially amorphous, or may be partially crystalline (semi-crystalline). The polyester and/or the skin layer may have a crystallinity of at least about, and/or at most about, any of the following weight percentages: 5, 10, 15, 20, 25, 30, 35, 40, and 50%.

The crystallinity may be determined indirectly by the thermal analysis method, which uses heat-of-fusion measurements made by differential scanning calorimetry (“DSC”). All references to crystallinity percentages of a polymer, a polymer mixture, a resin, a film, or a layer in this Application are by the DSC thermal analysis method, unless otherwise noted. The DSC thermal analysis method is believed to be the most widely used method for estimating polymer crystallinity, and thus appropriate procedures are known to those of skill in the art. See, for example, “Crystallinity Determination,” Encyclopedia of Polymer Science and Engineering, Volume 4, pages 482-520 (John Wiley & Sons, 1986), of which pages 482-520 are incorporated herein by reference.

Under the DSC thermal analysis method, the weight fraction degree of crystallinity (i.e., the “crystallinity” or “Wc”) is defined as ΔHi/ΔHi where “ΔHP is the measured heat of fusion for the sample (i.e., the area under the heat-flow versus temperature curve for the sample) and “AHf,c” is the theoretical heat of fusion of a 100% crystalline sample. The AHf,c values for numerous polymers have been obtained by extrapolation methods; see for example, Table 1, page 487 of the “Crystallinity Determination” reference cited above. The AHf,c for polymers are known to, or obtainable by, those of skill in the art. The AHf,c for a sample polymer material may be based on a known AHf,c for the same or similar class of polymer material, as is known to those of skill in the art. For example, the AHf,c for polyethylene may be used in calculating the crystallinity of an EVA material, since it is believed that it is the polyethylene backbone of EVA rather than the vinyl acetate pendant portions of EVA that forms crystals. Also by way of example, for a sample containing a blend of polymer materials, the AHf,c for the blend may be estimated using a weighted average of the appropriate AHf,c for each of the polymer materials of separate classes in the blend.

The DSC measurements may be made using a thermal gradient for the DSC of 10° C./minute. The sample size for the DSC may be from 5 to 20 mg.

In various embodiment, the heat seal layer has a melting point less than any of the following values: 220° C., 210° C., 200° C., 190° C., 180° C., 170° C., 160° C., 150° C., 140° C. and 130° C.; and the melting point of the heat seal layer may be at least any of the following values: 50° C., 60° C., 70,° C., 80° C., 90° C., 100° C., 110° C., 120° C., 130° C., 140° C., and 150° C. In an embodiment, the heat seal layer comprises from 80 to 99 wt % of a linear low density polyethylene copolymer having a melting point between 90-130° C. In an embodiment, the heat seal layer comprises from 80 to 99 wt % of a very low density polyethylene copolymer having a melting point between 85-125° C. All references to the melting point of a polymer, a resin, or a film layer in this application refer to the melting peak temperature of the dominant melting phase of the polymer, resin, or layer as determined by differential scanning calorimetry according to ASTM D-3418.

In embodiments where the heat seal layer comprises amorphous material, then the heat seal layer may not clearly display a melting point. The glass transition temperature for the heat seal layer may be less than, and may range between, any of the following values: 125° C., 120° C., 110° C., 100° C., 90° C., 80° C., 70° C., 60° C., 50° C., 40° C., 30° C. and 25° C.; measured where the relative humidity may be any of the following values: 100%, 75%, 50%, 25%, and 0%. All references to the glass transition temperature (T_{g}) of a polymer was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis,” which is hereby incorporated, in its entirety, by reference thereto.

In various embodiment, the heat seal layer has a seal initiation temperature less than any of the following values: 220° C., 210° C., 200° C., 190° C., 180° C., 170° C., 160° C., 150° C., 140° C. and 130° C.; and the seal initiation temperature of the heat seal layer may be at least any of the following values: 50° C., 60° C., 70° C., 80° C., 90° C., 100° C., 110° C., 120° C., 130° C., 140° C., and 150° C.

In an embodiment the heat seal layer has a melt index or composite melt index of at least 0.3, 0.5, 1.0, 1.5, 2.0, 2.5, 3.0, 4.0, 5.0, 6.0, 7.0, 8.0, 9.0 or 10 g/10 min @190° C. and 2.16 kg measured in accordance with ASTM D1238.

The thickness of the heat seal layer may be selected to provide sufficient material to affect a strong heat seal bond, yet not so thick so as to negatively affect the characteristics of the film to an unacceptable level. The heat seal layer may have a thickness of at least any of the following values: 0.05 mils, 0.1 mils, 0.15 mils, 0.2 mils, 0.25 mils, 0.3 mils, 0.35 mils, 0.4 mils, 0.45 mils, 0.5 mils, and 0.6 mils. The heat seal layer may have a thickness less than any of the following values: 5 mils, 4 mils, 3 mils, 2 mils, 1 mil, 0.7 mils, 0.5 mils, and 0.3 mils. The thickness of the heat seal layer as a percentage of the total thickness of the film may be less that any of the following values: 50%, 40%, 30%, 25%, 20%, 15%, 10%, and 5%; and may range between any of the forgoing values (e.g., from 10% to 30%).

Reclaim Layer

In embodiments, the reclaim layer includes a blend of a number of materials and may be made from scrap content. As used herein, “scrap content” refers to materials that originate from a non-virgin source. The scrap content can be reclaimed from materials including, but not limited to, cut scraps; trimmed materials; transition materials; off spec material; start up, shut down or flush material, post-industrial and post-consumer recycled materials. The amount of scrap content in a layer/film is calculated based on the percent weight of scrap material as compared to other materials in the layer/film. The reclaim layer includes a polyolefin such as polyethylene as a first component and at least one heat resistant polymer or blend of heat resistant polymers as a second component. The heat resistant polymer has a melting point (if present) of at least any of the following values: 250° C., 240° C., 230° C., 220° C., 210° C., 200° C., 190° C., 180° C., 170° C., 160° C., 150° C., 140° C., 130° C. and 120° C. The second component including polyamide, ethylene vinyl alcohol, polypropylene, polyester, and blends thereof. To aid in miscibility of the blend, compatibilizers and antioxidants are included. Useful compatibilizers include, ethylene acrylic acid copolymers and ethylene-methacrylic-acid-copolymers. In embodiments the compatibilizer is present in the polymeric mixture in an amount between 1 and 10 wt %. In an embodiment the compatibilizer is present in the polymeric mixture at no more than 10 wt %.

In an embodiment, the reclaim layer includes between any of 5 and 95 wt %, 7 and 90 wt %, 10 and 85 wt %, 15 and 80 wt %, 20 and 70 wt % polyolefin. In embodiments, the reclaim layer has less than 95 wt % polyolefin. In embodiments, the reclaim layer has less than 90 wt % polyolefin. In embodiments, the polyolefin is a polyethylene or polyethylene copolymer.

The heat resistant polymer is present in the reclaim layer in an amount of at least 5 wt %, 6 wt %, 7 wt %, 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the reclaim layer. In various embodiments, the heat resistant polymer is present in the reclaim layer in an amount between 5 and 95 wt %, between 10 and 90 wt %, between 15 and 70 wt %, between 20 and 60 wt %, or between 25 and 50 wt % as compared to the total weight of the reclaim layer.

In an embodiment, the heat resistant polymer is a polyamide. The polyamide being present in amount of at least 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the reclaim layer. In an embodiment, the polyamide is present in amount between 15 and 30 wt %. In an embodiment, the polyamide is polyamide 6, polyamide 6/66, amorphous (6I/6T) or blends thereof.

In an embodiment, the heat resistant polymer is ethylene vinyl alcohol. The ethylene vinyl alcohol being present in amount of at least 4 wt %, 5 wt %, 6 wt %, 7 wt %, 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the reclaim layer.

In an embodiment, the heat resistant polymer is a polyester. The polyester being present in amount of at least 4 wt %, 5 wt %, 6 wt %, 7 wt %, 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the reclaim layer. In an embodiment, the polyester is present in amount of at between 4 and 80 wt %, 6 and 60 wt %, 8 and 40 wt % or 10 and 20 wt % as compared to the total weight of the reclaim layer.

In an embodiment, the heat resistant polymer is polypropylene. The polypropylene being present in amount of at least 4 wt %, 5 wt %, 6 wt %, 7 wt %, 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the reclaim layer. In an embodiment, the polypropylene is present in amount of at between 4 and 80 wt %, 6 and 60 wt %, 8 and 40 wt % or 10 and 20 wt % as compared to the total weight of the reclaim layer.

In an embodiment, the reclaim layer is a blend of materials that includes polyethylene and at least two of polyamide, ethylene vinyl alcohol, polypropylene, polyester.

In an embodiment, the reclaim layer is a blend of materials that includes polyethylene and at least three of polyamide, ethylene vinyl alcohol, polypropylene, polyester. In an embodiment, the reclaim layer is a blend of materials that includes polyethylene, polyamide, ethylene vinyl alcohol, polypropylene, polyester. In an embodiment, the reclaim layer includes at least 8%, 9%, 10%, 10%, 11%, 12%, 13%, 14%, 15%, 16%, 17%, 18%, 19%, 20%, 25%, 30%, 35% or 40% polyamide and at least 4%, 5%, 6%, 7%, 8%, 9% or 10% ethylene vinyl alcohol. In an embodiment, the reclaim layer further includes at least 4%, 5%, 6%, 7%, 8%, 9%, 10%, 15%, 20% or 25% polypropylene and/or polyester.

In an embodiment the reclaim layer has a melt index of less than 1.0, 0.5, 0.4, 0.3, 0.2, 0.1 g/10 min @190° C. and 2.16 kg measured in accordance with ASTM D1238. In an embodiment the reclaim layer may have zero melt index @190° C. and 2.16 kg measured in accordance with ASTM D1238.

In an embodiment the reclaim layer further includes 0.05-5.0 wt % of an antioxidant. An antioxidant, as defined herein, is any material which inhibits oxidative degradation or cross-linking of polymers. Examples of antioxidants suitable for use are, for example, hindered phenolics, such as, 2,6-di(t-butyl)4-methyl-phenol(BHT), 2,2″-methylene-bis(6-t-butyl-p-cresol); phosphites, such as, triphenylphosphite, tris-(nonylphenyl)phosphite; and thiols, such as, dilaurylthiodipropionate; pentaerythritol tetrakis(3-(3,5-di-tert-butyl-4-hydroxyphenyl)propionate); octadecyl 3-(3,5-di-tert-butyl-4-hydroxyphenyl)propionate and the like.

In various embodiments, the reclaim layer has a melting point of at least any of the following values: 250° C., 240° C., 230° C., 220° C., 210° C., 200° C., 190° C., 180° C., 170° C., 160° C., 150° C., 140° C., 130° C. and 120° C.; and the melting point of the reclaim layer may be less than any of the following values: 300° C., 290° C., 280° C., 270° C., 260° C., and 250° C. All references to the melting point of a polymer, a resin, or a film layer in this application refer to the melting peak temperature of the dominant melting phase of the polymer, resin, or layer as determined by differential scanning calorimetry according to ASTM D-3418.

In embodiments where the reclaim layer comprises amorphous material, then the reclaim layer may not clearly display a melting point. The glass transition temperature for the reclaim layer may be at least, and may range between, any of the following values: 120° C., 110° C., 100° C., 90° C., 80° C., 70° C., 60° C., 50° C., 40° C., 30° C., and 20° C.; measured where the relative humidity may be any of the following values: 100%, 75%, 50%, 25%, and 0%. All references to the glass transition temperature (T_{g}) of a polymer was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis,” which is hereby incorporated, in its entirety, by reference thereto.

In various embodiments, the reclaim layer has a seal initiation temperature of at least any of the following values: 250° C., 240° C., 230° C., 220° C., 210° C., 200° C., 190° C., 180° C., 170° C., 160° C., 150° C., 140° C., 130° C. and 120° C.; and the seal initiation of the reclaim layer may be less than any of the following values: 300° C., 290° C., 280° C., 270° C., 260° C., and 250° C.

The thickness of the reclaim layer may be selected to provide sufficient material to affect a desired reclaim, yet not so thick so as to negatively affect the characteristics of the film to an unacceptable level. The reclaim layer may have a thickness of at least any of the following values: 0.035, 0.05 mils, 0.1 mils, 0.15 mils, 0.2 mils, 0.25 mils, 0.3 mils, 0.35 mils, 0.4 mils, 0.45 mils, 0.5 mils, and 0.6 mils. The reclaim layer may have a thickness less than any of the following values: 5 mils, 4 mils, 3 mils, 2 mils, 1 mil, 0.7 mils, 0.5 mils, and 0.3 mils. The thickness of the reclaim layer as a percentage of the total thickness of the film may be less that any of the following values: 80, 70, 60, 50%, 40%, 30%, 25%, 20%, 15%, 10%, and 5%; and may range between any of the forgoing values (e.g., from 10% to 30%).

In embodiments the reclaim layer and the heat seal layer have a difference in seal initiation temperature of at least 10° C., 20° C., 30° C., 40° C., 50° C., 60° C., 70° C., 80° C., 90° C. or 100° C. In embodiments the reclaim layer and the heat seal layer have a difference in seal initiation temperature of between 10° C. and 100° C., 20° C. and 90° C., or 30° C. and 80° C. The reclaim layer having a higher seal initiation temperature than the seal initiation temperature of the heat seal layer.

In embodiments the melting point or glass transition temperature of the reclaim layer is at least 10° C., 20° C., 30° C., 40° C., 50° C., 60° C., 70° C., 80° C., 90° C. or 100° C. higher than the seal initiation temperature of the heat seal layer. In embodiments the difference between the melting point or glass transition temperature of the reclaim layer and the seal initiation temperature of the heat seal layer is between 10° C. and 100° C., 20° C. and 90° C., or 30° C. and 80° C. The seal initiation temperature of the heat seal layer being the lower temperature.

The film may comprise one or more intermediate layers, such as a tie layer. In addition to a first intermediate layer, the film may comprise a second intermediate layer. “Intermediate” herein refers to a layer of a multi-layer film which is between an outer layer and an inner layer of the film. “Inner layer” herein refers to a layer which is not an outer or surface layer, and is typically a central or core layer of a film. “Outer layer” herein refers to what is typically an outermost, usually surface layer or skin layer of a multi-layer film, although additional layers, coatings, and/or films can be adhered to it.

In embodiments with multiple intermediate layers, the composition, thickness, and other characteristics of a second intermediate layer may be substantially the same as any of those of a first intermediate layer, or may differ from any of those of the first intermediate layer.

An intermediate layer may be, for example, between the heat seal layer and the reclaim layer. An intermediate layer may be directly adjacent the heat seal layer, so that there is no intervening layer between the intermediate and heat seal layers. An intermediate layer may be directly adjacent the reclaim layer, so that there is no intervening layer between the intermediate and reclaim layers. An intermediate layer may be directly adjacent both the heat seal layer and the reclaim layer.

An intermediate layer may have a thickness of at least about, and/or at most about, any of the following: 0.05, 0.1, 0.15, 0.2, 0.25, 0.5, 1, 2, 3, 4, and 5 mils. The thickness of the intermediate layer as a percentage of the total thickness of the film may be at least about, and/or at most about, any of the following: 1, 3, 5, 7, 10, 15, 20, 25, 30, 35, 40, 45, and 50 percent.

An intermediate layer may comprise one or more of any of the tie polymers described herein in at least about, and/or at most about, any of the following amounts: 10, 20, 30, 40, 50, 60, 70, 75, 80, 90, 95, and 99.5%, by weight of the layer.

A tie layer refers to an internal film layer that adheres two layers to one another. Useful tie polymers include thermoplastic polymers that may be compatible both with the polymer of one directly adjacent layer and the polymer of the other directly adjacent layer. Such dual compatibility enhances the adhesion of the tied layers to each other. Tie layers can be made from polyolefins such as modified polyolefin, ethylene/vinyl acetate copolymer, modified ethylene/vinyl acetate copolymer, and homogeneous ethylene/alpha-olefin copolymer. Typical tie layer polyolefins include anhydride modified grafted linear low density polyethylene, anhydride grafted (i.e., anhydride modified) low density polyethylene, anhydride grafted polypropylene, anhydride grafted methyl acrylate copolymer, anhydride grafted butyl acrylate copolymer, homogeneous ethylene/alpha-olefin copolymer, and anhydride grafted ethylene/vinyl acetate copolymer.

In an embodiment the tie layer includes a polyolefin. In embodiments, the tie layer includes at least 0.5, 1.0, 1.5, 2.0, 2.5 or 3.0% by weight of a polymer found in adjacent layers.

Barrier Layer

The multilayer film may further includes a barrier layer. As used herein, the term “barrier”, and the phrase “barrier layer”, as applied to films and/or film layers, are used with reference to the ability of a film or film layer to serve as a barrier to one or more gases. Oxygen transmission rate is one method to quantify the effect of a barrier layer. As used herein, the term “oxygen transmission rate” refers to the oxygen transmitted through a film in accordance with ASTM D3985 “Standard Test Method for Oxygen Gas Transmission Rate Through Plastic Film and Sheeting Using a Coulometric Sensor,” which is hereby incorporated, in its entirety, by reference thereto.

The barrier layer or combination of barrier layers typically have low oxygen permeability. For example, the oxygen barrier layer(s) may result in a multi-layer film having an oxygen transmission rate of 500 cc(STP)/m2/24 hrs/latm or less, and in particular, less than 450, less than 400, less than 350, less than 300, less than 250, less than 200, less than 150, less than 100, less than 80, and less than 50 cc(STP)/m2/24 hrs/latm.

The film may comprise one or more other layers such as a bulk layer. Bulk layers are often a layer or layers of a film that can increase the abuse resistance, toughness, or modulus of a film. In some embodiments the film comprises a bulk layer that functions to increase the abuse resistance, toughness, and/or modulus of the film. Bulk layers generally comprise polymers that are inexpensive relative to other polymers in the film that provide some specific purpose unrelated to abuse-resistance, modulus, etc. In an embodiment, the bulk layer comprises at least one member selected from the group consisting of: ethylene/alpha-olefin copolymer, ethylene homopolymer, propylene/alpha-olefin copolymer, propylene homopolymer, and combinations thereof. The bulk layer may comprise all or in part recycled or reclaimed material. The bulk layer may comprise at least 50 wt % recycled or reclaimed material.

The bulk layer may have a thickness of at least about, and/or at most about, any of the following: 0.05, 0.1, 0.15, 0.2, 0.25, 0.5, 1, 2, 3, 4, and 5 mils. The thickness of the bulk layer as a percentage of the total thickness of the film may be at least about, and/or at most about, any of the following: 1, 3, 5, 7, 10, 15, 20, 25, 30, 35, 40, 45, and 50 percent.

The film may be manufactured by thermoplastic film-forming processes known in the art. The film may be prepared by extrusion or coextrusion utilizing, for example, a tubular trapped bubble film process or a flat film (i.e., cast film or slit die) process. The film may also be prepared by applying one or more layers by extrusion coating, adhesive lamination, extrusion lamination, solvent-borne coating, or by latex coating (e.g., spread out and dried on a substrate). A combination of these processes may also be employed.

The film may be oriented in either the machine (i.e., longitudinal), the transverse direction, or in both directions (i.e., biaxially oriented), for example, to enhance the strength, optics, and durability of the film. A web or tube of the film may be uniaxially or biaxially oriented by imposing a draw force at a temperature where the film is softened (e.g., above the vicat softening point; see ASTM 1525) but at a temperature below the film's melting point. The film may then be quickly cooled to retain the physical properties generated during orientation and to provide a heat-shrink characteristic to the film. The film may be oriented using, for example, a tenter-frame process or a bubble process (double bubble, triple bubble and likewise). These processes are known to those of skill in the art, and therefore are not discussed in detail here. The orientation may occur in at least one direction by at least about, and/or at most about, any of the following ratios: 1.5:1, 2:1, 2.5:1, 3:1, 3.5:1 , 4:1, 5:1, 6:1, 7:1, 8:1, 9:1, 10:1, 12:1, and 15:1.

The term “bond strength” as used herein means the amount of force required to separate or delaminate the film at adjacent film layers by adhesive failure, or to cause cohesive failure within an adjacent layer, plus the force to bend the layers during the test, as measured in accordance with ASTM F904, using an Instron tensile tester crosshead speed of 10 inches per minute and five, 1-inch wide, representative samples while supporting the unseparated portion of each test specimen at 90° to the direction of draw. An “adhesive failure” is a failure in which the interfacial forces (e.g., valence forces or interlocking action or both) holding two surfaces together are overcome.

The minimum bond strength of the film is the weakest bond strength indicated from the testing of the separation at each of the layers of the film. The minimum bond strength indicates the internal strength with which a film remains intact to function as a single unit. The bond strength is provided both by inter-layer adhesion (i.e., the inter-layer adhesive bond strength) and by the intra-layer cohesion of each film layer (i.e., the intra-layer cohesive strength).

The minimum bond strength of the film may be at least about any of the following: 1, 1.5, 2, 2.5, 2.6, 2.8, 3, 3.5, 4, and 4.5 pounds/inch. The minimum bond strength between each of the adjacent layers of a plurality of layers of the film may be at least about any of the values in the preceding sentence, measured according to ASTM F904.

The minimum bond strength between the intermediate layer and each of the layers directly adjacent the intermediate layer may be at least about any of the following: 1, 1.5, 2, 2.5, 2.6, 2.8, 3, 3.5, 4, and 4.5 pounds/inch measured according to ASTM F904.

In embodiments the multi-layer film structure has an oxygen transmission rate of no more than: 5, 10, 15, 20, 25, 30, 35, 40, 45, 50, 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900 or 4000 cubic centimeters (at standard temperature and pressure) per square meter per day per 1 atmosphere of oxygen pressure differential measured at 0% relative humidity and 23° C. measured according to ASTM D-3985 which is hereby incorporated by reference in its entirety. In embodiments the multi-layer film structure has an oxygen transmission rate of less than 4000, 3000, 2000 or 1000 cubic centimeters (at standard temperature and pressure) per square meter per day per 1 atmosphere of oxygen pressure differential measured at 0% relative humidity and 23° C. measured according to ASTM D-3985. Unless otherwise stated, OTR values provided herein are measured at 0% relative humidity and at a temperature of 23° C.

In an embodiment, the film has a total polyamide content of between 1 and 30 wt %. In an embodiment, the film has a total polyamide content of between 2 and 20 wt %.

In an embodiment, the film has a total polyamide content of between 3 and 12 wt %. In an embodiment, the film has a total polyamide content of between 4 and 8 wt %.

In an embodiment, the film has a total polyolefin content of between 70 and 99 wt %. In an embodiment, the film has a total polyolefin content of between 80 and 95 wt %. In an embodiment, the film has a total polyolefin content of between 85 and 90 wt %.

Film transparency (also referred to herein as film clarity) was measured in accordance with ASTM D 1746-97 “Standard Test Method for Transparency of Plastic Sheeting”, published April 1998, which is hereby incorporated, in its entirety, by reference thereto. The results are reported herein as “percent transparency”. The multilayer film can exhibit a transparency of at least 15 percent, or at least 20 percent, or at least 25 percent, or at least 30 percent, measured using ASTM D 1746-97.

Film haze values were measured in accordance with ASTM D 1003-00 “Standard Test Method for Haze and Luminous Transmittance of Transparent Plastics”, published July 2000, which is hereby incorporated, in its entirety, by reference thereto. The results are reported herein as “percent haze”. The multilayer film can exhibit a haze of less than 7.5 percent, or less than 7 percent, or less than 6 percent, measured using ASTM D 1003-00.

Film gloss values were measured in accordance with ASTM D 2457-97 “Standard Test Method for Specular Gloss of Plastic Films and Solid Plastics”, published Jan. 10, 1997, which is hereby incorporated, in its entirety, by reference thereto. The results are reported herein as “percent gloss”. The film can exhibit a gloss, as measured using ASTM D 2457-97, of from 60% to 100%, or from 70% to 90%.

In embodiments the packaging article is a printed packaging article. The outside layer of the film provides the surface upon which a printed image is applied, such as by printing ink. In other embodiments, the printing is done by trap printing.

For exterior printing, a printed image is applied to the non-food contact side of the film. To form the printed image, one or more layers of ink are printed on the film. The ink is selected to have acceptable ink adhesion, gloss, and heat resistance once printed on the film substrate. Acceptable ink adhesions include (in ascending order of preference) at least 50%, at least 60%, at least 70%, at least 80%, at least 90%, and at least 95%, as measured by ASTM D3359-93, as adapted by those of skill in the film print art. The ink system may be radiation curable, solvent-based or water-based.

Solvent-based inks for use in printing packaging films include a colorant (e.g., pigment) dispersed in a vehicle that typically incorporates a resin (e.g., nitrocellulose, polyamide), a solvent (e.g., an alcohol), and optional additives. Inks and processes for printing on plastic films are known to those of skill in the art. See, for example, Leach & Pierce, The Printing Ink Manual, (5Supth/Suped., Kluwer Academic Publishers, 1993) and U.S. Pat. No. 5,407,708 to Lovin et al., each of which is incorporated herein in its entirety by reference.

Examples of solvent-based ink resins include those which have nitrocellulose, amide, urethane, epoxide, acrylate, and/or ester functionalities. Ink resins include one or more of nitrocellulose, polyamide, polyurethane, ethyl cellulose, (meth)acrylates, poly(vinyl butyral), poly(vinyl acetate), poly(vinyl chloride), and polyethylene terephthalate (PET). Ink resins may be blended, for example, as nitrocellulose/polyamide blends (NC/PA) or nitrocellulose/polyurethane blends (NC/PU).

Examples of ink solvents include one or more of water solvent or hydrocarbon solvent, such as alcohols (e.g., ethanol, 1-propanol, isopropanol), acetates (e.g., n-propyl acetate), aliphatic hydrocarbons, aromatic hydrocarbons (e.g., toluene), and ketones. The solvent may be incorporated in an amount sufficient to provide inks having viscosities, as measured on a #2 Zahn cup as known in the art, of at least about 15 seconds, preferably of at least about 20 seconds, more preferably of at least about 25 seconds, even more preferably of from about 25 to about 45 seconds, and most preferably from about 25 to about 35 seconds.

The film may be printed by any suitable method, such as rotary screen, gravure, inkjet or flexographic techniques, as is known in the art. Once a solvent or water-based ink is applied to the substrate film, the solvent or water evaporates, leaving behind the resin-pigment combination. The solvent or water may evaporate as a result of heat or forced air exposure to speed drying. The ink may be applied in layers, each with a different color, to provide the desired effect. Optionally, the last print station may be used to apply an overprint varnish (discussed below).

A radiation-curable ink system may incorporate one or more colorants (e.g., pigments) with the monomers and oligomer/prepolymers as discussed below with respect to the radiation-curable overprint varnish. Application and curing of a radiation-curable ink is similar to that as discussed in that section. In embodiments, each of the inks used to make the printed markings on the substrate film surface are essentially free of photoinitiators, thus eliminating the possibility that such materials may migrate toward and into the product to be packaged.

To improve the adhesion of the ink to the surface of the substrate film, the surface of the substrate film may be treated or modified before printing. Surface treatments and modifications include: i) mechanical treatments, such as corona treatment, plasma treatment, and flame treatment, and ii) primer treatment. Surface treatments and modifications are known to those of skill in the art. The flame treatment is less desirable for a heat-shrinkable film, since heat may prematurely shrink the film. The primer may be based on any of the ink resins previously discussed. The ink on the printed film should withstand without diminished performance the temperature ranges to which it will be exposed during packaging and use. For example, the ink on the printed film preferably withstands physical and thermal abuse (e.g., heat sealing) during packaging end-use, such as at temperatures of (in ascending order of preference) 100° C., 125° C., 150° C., and 175° C. for 3 seconds, more preferably 5 seconds, and most preferably 8 seconds.

Optionally, an overprint varnish (i.e., overcoat) may be applied to the printed side of the printed substrate film to cover at least the printed image of the printed substrate film. In embodiments, the overprint varnish covers a substantial portion of the printed image—that is, covering a sufficient portion of the printed image to provide the desired performance enhancements. In embodiments the overprint varnish is transparent.

The overprint varnish may be formed or derived from a radiation-curable (i.e., radiation-polymerizable) overprint varnish system. Such a system has the ability to change from a fluid phase to a highly cross-linked or polymerized solid phase by means of a chemical reaction initiated by a radiation energy source, such as ultra-violet (“UV”) light or electron beam (“EB”) radiation. Thus, the reactants of the radiation-curable overprint varnish system are “cured” by forming new chemical bonds under the influence of radiation. Radiation-curable inks and varnish systems are described in The Printing Ink Manual, Chapter 11, pp. 636-77 (5Supth/Suped., Kluwer Academic Publishers, 1993), of which pages 636-77 are incorporated in their entirety by reference.

The radiation-cured overprint varnish provides a protective covering having good flexibility without cracking; yet, since the radiation-cured overprint varnish is cross-linked after irradiation, the varnish resin is less likely to flow when exposed to heat during a heat seal operation. Further, the radiation-cured overprint varnish improves the abrasion resistance and gloss of the coated, printed substrate.

In an embodiment, the film has a composite melt index of at least any of the following values 0.1, 0.3, 0.5, 1.0, 1.5, 2.0, 2.5, 3.0, 4.0 or 5.0 g/10 min @190° C. and 2.16 kg measured in accordance with ASTM D1238.

As used herein, the phrase “food product” includes bakery items such as breads, bagels, donuts, muffins, scones and the like. Food products further includes chesses such as shredded cheese. Food products also include snack items such as chips, cookies, crackers, nuts, mixes and the like. Food products also include frozen foods such as fruits, vegetables, meats and prepared meals.

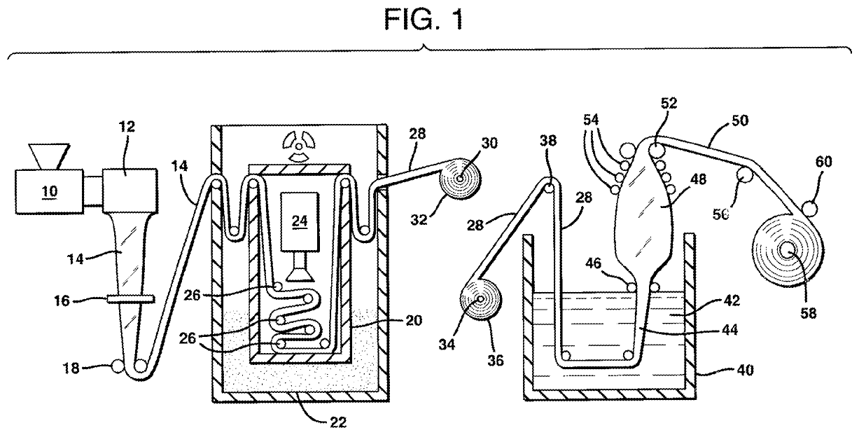

FIG. 1 illustrates a process for making a “substrate film” which can thereafter be coated so that it becomes a film in accordance with the present invention. In the process illustrated in FIG. 1, various polymeric formulations solid polymer beads (not illustrated) are fed to a plurality of extruders (for simplicity, only one extruder is illustrated). Inside extruders 10, the polymer beads are degassed, following which the resulting bubble-free melt is forwarded into die head 12, and extruded through an annular die, resulting in tubing tape 14 which is preferably from about 15 to 30 mils thick, and preferably has a lay-flat width of from about 2 to 10 inches.

After cooling or quenching by water spray from cooling ring 16, tubing tape 14 is collapsed by pinch rolls 18, and is thereafter fed through irradiation vault 20 surrounded by shielding 22, where tubing 14 is irradiated with high energy electrons (i.e., ionizing radiation) from iron core transformer accelerator 24. Tubing 14 is guided through irradiation vault 20 on rolls 26. Preferably, tubing tape 14 is irradiated to a level of from about 40-100 kGy, resulting in irradiated tubing 28. Irradiated tubing tape 28 is wound upon windup roll 30 upon emergence from irradiation vault 20, forming irradiated tubing tape coil 32.

After irradiation and windup, windup roll 30 and irradiated tubing tape coil 32 are removed and installed as unwind roll 34 and unwind tubing tape coil 36, on a second stage in the process of making the tubing film as ultimately desired. Irradiated tubing 28, being unwound from unwind tubing tape coil 36, is then passed over guide roll 38, after which irradiated tubing 28 is passed through hot water bath tank 40 containing hot water 42. Irradiated tubing 28 is then immersed in hot water 42 (preferably having a temperature of about 85° C. to 99° C.) for a period of about 20 to 60 seconds, i.e., for a time period long enough to bring the film up to the desired temperature for biaxial orientation. Thereafter, hot, irradiated tubular tape 44 is directed through nip rolls 46, and bubble 48 is blown, thereby transversely stretching hot, irradiated tubular tape 44 so that oriented film tube 50 is formed. Furthermore, while being blown, i.e., transversely stretched, nip rolls 52 have a surface speed higher than the surface speed of nip rolls 46, thereby resulting in longitudinal orientation. As a result of the transverse stretching and longitudinal drawing, oriented film tube 50 is produced, this blown tubing preferably having been both stretched in a ratio of from about 1:1.5 to 1:6, and drawn in a ratio of from about 1:1.5 to 1:6. More preferably, the stretching and drawing are each performed at a ratio of from about 1:2 to 1:4. The result is a biaxial orientation of from about 1:2.25 to 1:36, more preferably, 1:4 to 1:16. While bubble 48 is maintained between nip rolls 46 and 52, blown film tube 50 is collapsed by converging pairs of parallel rollers 54, and thereafter conveyed through nip rolls 52 and across guide roll 56, and then rolled onto wind-up roll 58. Idler roll 60 assures a good wind-up.

The resulting multilayer film can be used to form bags, casings, thermoformed articles and lidstocks therefor, etc., which, in turn, can be used for the packaging of food-containing products. While various embodiments are illustrated and described herein, other packaging structures, such as resealable bags, side seal bags, vertical form filled bags, vertical pouch packaging, end seal bags, lap seal bags and the like are contemplated.

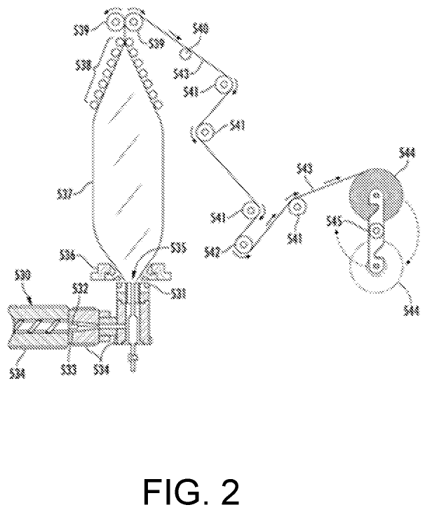

In embodiments, the film was produced by the blown film process illustrated in FIG. 2, which illustrates a schematic view of a process for making a “hot-blown” film, which is oriented in the melt state, and therefore is not heat-shrinkable. Although only one extruder 139 is illustrated in FIG. 2, it is understood that more than one extruder can be utilized to make the films.

In the process of FIG. 2, extruder 530 supplied molten polymer to annular die 531 for the formation of the film, which can be monolayer or multilayer, depending upon the design of the die and the arrangement of the extruder(s) relative to the die, as known to those of skill in the art. Extruder 530 was supplied with polymer pellets suitable for the formation of the film. Extruder 530 subjected the polymer pellets to sufficient heat and pressure to melt the polymer and forward the molten stream through annular die 531.

Extruder 530 was equipped with screen pack 532, breaker plate 533, and heaters 534. The film was extruded between mandrel 535 and die 531, with the resulting extrudate being cooled by cool air from air ring 536. The molten extrudate was immediately blown into blown bubble 537, forming a melt oriented film. The melt oriented film cooled and solidified as it was forwarded upward along the length of bubble 537. After solidification, the film tubing passed through guide rolls 538 and was collapsed into lay-flat configuration by nip rolls 539. The collapsed film tubing was optionally passed over treater bar 540, and thereafter over idler rolls 541, then around dancer roll 542 which imparted tension control to collapsed film tubing 543, after which the collapsed film tubing 543 was wound up as roll 544 via winder 545.

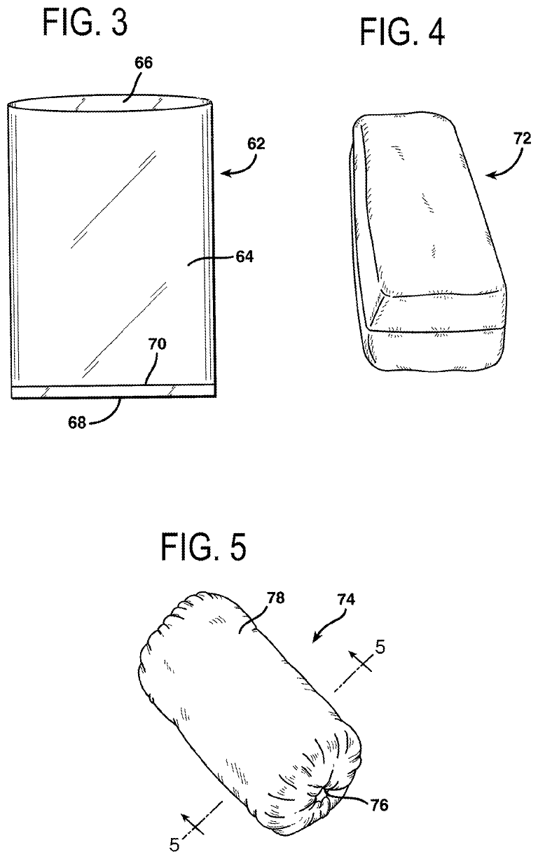

FIG. 3 illustrates bag 62 in lay-flat configuration. Bag 62 is made from film 64, and has open top 66, as well as bottom 68 closed by end-seal 70. An uncooked food product is placed inside bag 62, with bag 62 optionally thereafter being evacuated and sealed, resulting in packaged product 72 illustrated in FIG. 4.

FIG. 5 illustrates another embodiment of a packaged product 74, the product being packaged in a casing closed by a pair of clips 76 at each end thereof, with only one clip being illustrated in the perspective view of FIG. 5. Casing film 78, used to package food product inside the casing.

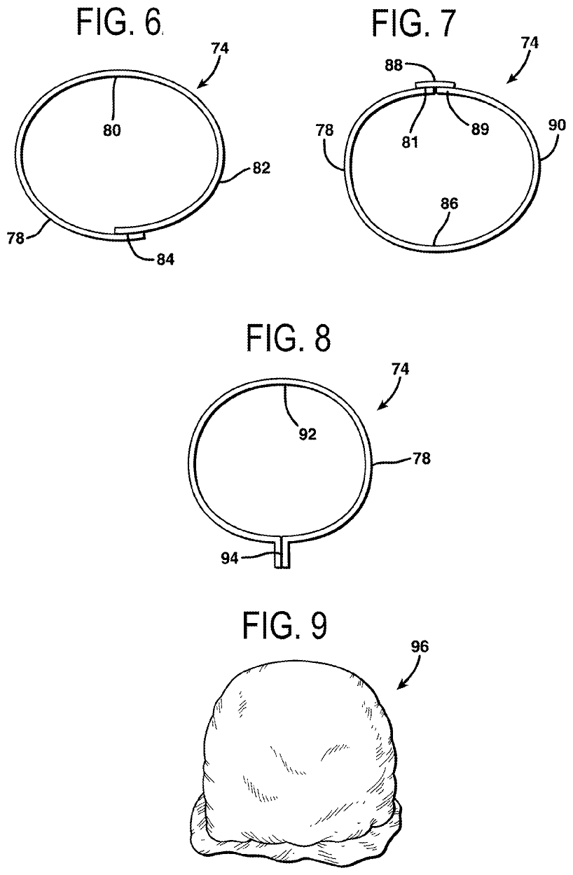

FIG. 6 illustrates a first cross-sectional view of packaged product 74, i.e., taken through line 5-5 of FIG. 5. FIG. 6 represents a cross-sectional view of a lap-sealed casing comprising film 78 having a coated inside surface 80, with an uncoated portion heat sealed to outside surface 82 at heat seal 84, the heat seal being located where a first film region overlaps a second film region.

FIG. 7 illustrates an alternative cross-sectional view of packaged product 74, i.e., analogous to the view of FIG. 6 but for a butt-sealed backseamed casing. FIG. 7 represents a cross-sectional view of a butt-sealed backseamed casing comprising film 78 having a coated inside surface 86. Casing film 78 is heat sealed to butt-seal tape 88. Casing film 78 has inside surface 86 and outside surface 90. Outside surface 90 is heat-sealed to butt-seal tape 88 at seals 81 and 89, where each of the edges of casing film 78 are abutted in close proximity to one another. In this manner, butt-seal tape 88 provides a longitudinal seal along the length of butt-sealed casing film 78. Although butt-seal tape 88 can be made from a monolayer film or a multilayer film, preferably butt-seal tape 88 is made from a multilayer film.

FIG. 8 illustrates a cross-sectional view of a third alternative of packaged product 74, i.e., a fin-sealed backseamed casing. In FIG. 8, fin-sealed casing film 78 optionally has a coated inside surface 92. Along the edges of the inside surface of casing film 78 are two uncoated regions which are heat sealed to one another at seal 94, which forms a “fin” which extends from casing 74.

In the packaging process resulting in the packaged product illustrated in FIG. 9, a forming web and a non-forming web can be fed from two separate rolls, with the forming web being fed from a roll mounted on the bed of the machine for forming the package “pocket,” i.e., the product cavity. The non-forming (lidstock) web is usually fed from a top-mounted arbor for completing the airtight top seal of the package. Each web has its food-contact/sealant surface oriented towards the other, so that at the time of sealing, the sealant surfaces face one another. The forming web is indexed forward by transport chains, and the previously sealed package pulls the upper non-forming web along with the bottom web as the machine indexes.

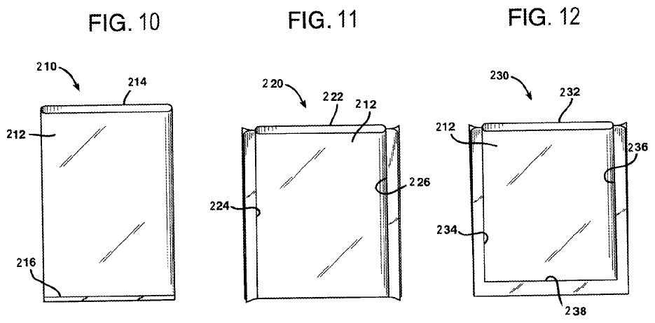

FIG. 10 is a side-view illustration of a preferred article (an end-seal bag) in accordance with the present invention. In FIG. 10, end-seal bag 210 is illustrated in lay-flat position. End-seal bag 210 is made from film 212, with end-seal bag 210 having open top 214 and end-seal 216.

FIG. 11 is a side-view illustration of another preferred article (a side-seal bag) in accordance with the present invention. In FIG. 11, side-seal bag 220 is illustrated in lay-flat position. Side-seal bag 220 is also made from film 212, and side seal bag has open top 222, and side seals 224 and 226.

FIG. 12 is a side-view illustration of another preferred article (a pouch) in accordance with the present invention. In FIG. 12, pouch 230 is illustrated in lay-flat position. Pouch 230 is also made from film 212, has open top 232, and side seals 234 and 236 and end seal 238.

While various embodiments of packaging articles made from the film described herein are exhibited. It is understood that additional packaging articles made from the film disclosed herein are contemplated. For example, the packaging article is sealed to itself to form a member selected from the group consisting of end-seal bag, side-seal bag, L-seal bag, U-seal pouch, gusseted pouch, lap-sealed form-fill-and-seal pouch, fin-sealed form-fill-and-seal pouch, stand-up pouch, and casing.

Melt Index Testing

The tools and equipment utilized in the Melt Index Test include: (i) DYNISCO Melt Indexer Model LMI 5000 melt flow indexer, with 2.16 kg of ergonomic stackable weights (ii) die cleaning and packaging rods (iii) wire brush for cleaning polymer residue off of the piston (iv) bit or brush for cleaning the die (v) cotton patches for cleaning the chamber (vi) spatula for cutting specimens (vii) funnel for pouring resins (viii) go/no-go gauge for checking die (die was checked every 6 months) (ix) aluminum pan (x) analytical balance accurate to 0.0001 gram, checked periodically to ensure that it was level (xi) stop watch (optional as DYNISCO Melt Indexer has a built-in timer); (xii) die plug (used if extrudate is flowing too fast).

In advance of and in preparation for the running of each melt index test (whether single resin melt index test or composite article melt index test), the DYNISCO Melt Indexer was kept turned on continuously. In advance of each test, the plunger was pulled out of the barrel holding the top insulator, and the die was pushed out and checked for cleanliness. Both the die and the plunger were cleaned before each test was conducted. The die and plunger were placed back in the barrel and reheated before each test was initiated.

Melt index measurements of individual resins, as disclosed in Table 1, were carried out in accordance with ASTM D1238, the disclosure of which is hereby incorporated, in its entirety, by reference thereto. In Table 1, the melt indices of the individual resins are disclosed as g/10 min @190 C and 2.16 kg, per ASTM D1238.

Composite Melt Index

The Composite Melt Index Test is a “composite test” in that it is carried out on an entire article. The Composite Melt Index Test is not a test carried out on a single resin present in an article to be recycled, or on a single component of an article to be recycled. Rather, the Composite Melt Index Test is always carried out on an article comprising two or more different resins in combination, and in this sense is a “composite” test.

The Composite Melt Index Test can be carried out on a multilayer film that is sealed to itself to make an article which may be, for example, a packaging article. The fact that the film is a multilayer film with at least two layers which differ in polymeric composition makes this melt index test an example of the Composite Melt Index Test. An article formed by bonding a multilayer film to itself, is considered to be a “first degree composite article”

Alternatively, the Composite Melt Index Test can be carried out on an assembly comprising a multilayer film which serves as a first component of the assembly, with the first component being bonded (e.g., heat sealed) to a second component of the assembly. The second component can have a polymeric composition which is the same as or different from the first component. If the first component and the second component are both identical multilayer films (another example of a first degree composite article), with each multilayer film having at least two layers which differ in polymeric composition, carrying out the melt index test on the assembly is a Composite Melt Index Test in that at least two different polymers are present in the assembly.

On the other hand, the Composite Melt Index Test can be carried out on an assembly of a first component (a multilayer film with at least two layers which differ in chemical composition) and a second component which has a different polymeric composition from the first component. Such an assembly article is a “second degree composite” in sense that it is a composite of a first component first and second components that are compositionally different. The phrase “second degree composite” is also inclusive of composites with three or more components with at least three of the three or more components being compositionally different from each other.

Composite Melt Index Test Procedure

The Composite Melt Index Test was carried out on composite articles (including first and second degree composite articles) by first cutting the composite article into strips followed by manually stuffing the strips into the barrel of a DYNISCO Melt Indexer Model LMI 5000 melt flow indexer, which was pre-calibrated by running a DuPont Elvax 3128 resin standard to make sure that the melt index fell within the 1.90-1.98 g/10 min range. If the composite article comprises fluid-filled chambers (i.e., chambers filled with gas or liquid), all chambers were burst before or as the composite article was cut into pieces of a size suitable to be manually stuffed into the barrel of the melt flow indexer.

Once a plurality of strips of a sample were cut, at least 4 test strips were manually stuffed into the barrel (inside diameter of 50.8 mm) of the melt flow indexer. Once the strips were in the barrel of the melt flow indexer, they were heated to 190° C. with the polyolefin therein melting so that the test strips formed a molten mass that was de-gassed by having the 2.16 kg weight on top of the piston for at least 390 seconds, which ensured that all gas bubbles exited the molten mass inside the barrel of the melt flow indexer before the material was allowed to flow through the die.

After degassing, the molten mass inside the barrel was allowed to flow down to the 2 mm orifice in the die inside the melt flow tester. The die thickness was 8 mm, which corresponded with the length of the 2 mm diameter passageway through the die. The test procedure measured the rate at which plastic flowed through the 8 mm long 2 mm diameter passageway through the die, while the plastic was heated to a temperature of 190 C and while the plastic was under a load of 2.16 kg. Unless otherwise specified, the melt index test procedure was carried out in accordance with ASTM D1238.

### EXAMPLES

The following examples are provided to illustrate various embodiments of films, and articles made therefrom. The various resins and other components used in the making of the films are provided in Table 1, below.

TABLE 1
Resins Used in Examples

| | | Resin MI | | |
|---|---|---|---|---|
| | | (g/10 min | | |
| | | @190 C./ | Resin | |
| Resin | | 2.16 kg) per | Density | |
| Identity | Resin | ASTM D1238 | g/cm³ | Supplier |
| LLDPE1 | SURPASS FPs117-C | 1.0 | 0.917 | Nova |
| | Ethylene/Octene linear low density | | | |
| | polyethylene | | | |
| LLDPE2 | GT4408 Modified linear low | 2.3 | 0.919 | Westlake |
| | density polyethylene | | | Chemical |
| VLDPE1 | AFFINITY PL 1850G Very Low | 3.0 | 0.902 | DOW |
| | Density Polyethylene | | | |
| MB1 | FSU 255E antiblock and slip in low | 9.0 | 1.08 | Schulman |
| | density polyethylene | | | |
| MB2 | AntiOxidant in linear low density | 2.5 | 0.932 | Ampacet |
| | polyethylene | | | |
| EAA1 | A-C 540 Ethylene/Acrylic Acid | | 0.93 | Honeywell |
| | Copolymer | | | |
| EAA2 | PRIMACOR 1410 Ethylene/Acrylic | 1.5 | 0.938 | SK |
| | Acid Copolymer | | | Chemicals |
| HDPE1 | SCLAIR 2607 ethylene butene | 4.6 | 0.947 | Nova |
| | copolymer | | | |
| TIE1 | Petrothene NA345013 Polyethylene | 1.8 | 0.921 | Lyondell |
| | Low Density Homopolymer | | | Basell |
| BLEND1 | Blend of ethylene vinyl acetate, | 0 | | |
| | polyolefins, ethylene vinyl alcohol | | | |
| | and polyamides | | | |
| BLEND2 | Blend of ethylene vinyl acetate, | 0 | | |
| | polyolefins, ethylene vinyl alcohol | | | |
| | and polyamides | | | |

BLEND1 and BLEND2 are blends of reclaim material made from scrap content. Scrap content can include, but is not limited to cut scraps; trimmed materials; transition materials; off spec material; start up, shut down or flush material. Due to the nature of obtaining scrap material, the exact composition of the blend may vary from batch to batch.

TABLE 2
film formulations

| | | | | 94% BLEND1 | 94% | 94% | | |
|---|---|---|---|---|---|---|---|---|
| | | 98% LLDPE1 | | & 5% | BLEND1 & | BLEND1 & | | |
| | | & | | EAA1 & 1% | 5% EAA1 | 5% EAA1 & | | |
| | | 2% MB1 | TIE1 | MB2 | & 1% MB2 | 1% MB2 | TIE1 | HDPE1 |
| Film 1 | Density | 0.922 | 0.921 | 0.98 | 0.98 | 0.98 | 0.921 | 0.947 |
| 53% | Layer % | 12.0% | 10.0% | 11.0% | 34.0% | 11.0% | 10.0% | 12.0% |
| scrap | Layer | 0.24 | 0.2 | 0.22 | 0.68 | 0.22 | 0.2 | 0.24 |
| | thickness | | | | | | | |
| | (mils) | | | | | | | |
| | | | | | 94% | | | |
| | | 98% LLDPE1 | | 90% BLEND1 | BLEND1 & | 90% | | |
| | | & | | & | 5% EAA1 | BLEND1 & | | 98% LLDPE1 |
| | | 2% MB1 | TIE1 | 10% LLDPE2 | & 1% MB2 | 10% LLDPE2 | TIE1 | & 2% MB1 |
| Film 2 | Density | 0.922 | 0.921 | 0.98 | 0.98 | 0.98 | 0.921 | 0.922 |
| 29% | Layer % | 15.0% | 19.0% | 8.0% | 16.0% | 8.0% | 19.0% | 15.0% |
| scrap | Layer | 0.3 | 0.38 | 0.16 | 0.32 | 0.16 | 0.38 | 0.3 |
| | thickness | | | | | | | |
| | (mils) | | | | | | | |
| | | | 94% | | 94% | | 94% | 94% |
| | | 97% | BLEND2 & | | BLEND2 & | 99% | BLEND2 & | BLEND2 & |
| | | VLDPE1 & | 5% EAA1 & | 99% BLEND2 | 5% EAA1 & | BLEND2 & | 5% EAA1 & | 5% EAA1 & |
| | | 3% MB1 | 1% MB2 | & 1% MB2 | 1% MB2 | 1% MB2 | 1% MB2 | 1% MB2 |
| Film 3 | Density | 0.903 | 0.98 | 0.98 | 0.98 | 0.98 | 0.98 | 0.98 |
| 85% | Layer % | 10.0% | 10.0% | 17.0% | 26.0% | 17.0% | 10.0% | 10.0% |
| scrap | Layer | 0.2 | 0.2 | 0.34 | 0.52 | 0.34 | 0.2 | 0.2 |
| | thickness | | | | | | | |
| | (mils) | | | | | | | |
| | | | 89% | | 89% | 89% | 89% | |
| | | | BLEND2 & | 89% BLEND2 | BLEND2 & | BLEND2 & | BLEND2 & | 94% |
| | | 97% | 5% EAA1 & | & 5% EAA1 & | 10% | 5% EAA1 & | 5% EAA1 & | BLEND2 & |
| | | VLDPE1 & | 1% MB2 | 1% MB2 | LLDPE2 & | 1% MB2 | 1% MB2 | 5% EAA1 & |
| | | 3% MB1 | & 5% EAA2 | & 5% EAA2 | 1% MB2 | & 5% EAA2 | & 5% EAA2 | 1% MB2 |
| Film 4 | Density | 0.903 | 0.978 | 0.978 | 0.973 | 0.978 | 0.978 | 0.98 |
| 82% | Layer % | 10.0% | 14.0% | 13.0% | 26.0% | 13.0% | 14.0% | 10.0% |
| scrap | Layer | 0.2 | 0.28 | 0.26 | 0.52 | 0.26 | 0.28 | 0.2 |
| | thickness | | | | | | | |
| | (mils) | | | | | | | |
| | | 97% | | | | | | |
| | | VLDPE1 & | | | | | | 98% TIE1 & |
| | | 3% MB1 | TIE1 | TIE1 | TIE1 | TIE1 | TIE1 | 2% MB1 |
| Film 5 | Density | 0.903 | 0.923 | 0.923 | 0.923 | 0.923 | 0.923 | 0.924 |
| 0% | Layer % | 10.0% | 14.0% | 13.0% | 26.0% | 13.0% | 14.0% | 10.0% |
| scrap— | Layer | 0.2 | 0.28 | 0.26 | 0.52 | 0.26 | 0.28 | 0.2 |
| 100% | thickness | | | | | | | |
| PE | (mils) | | | | | | | |

The film properties described herein are measured in accordance with ASTM D882 “Standard Test Method for Tensile Properties of Thin Plastic Sheeting,” ASTM D1938 “Standard Test Method for Tear-Propagation Resistance (Trouser Tear) of Plastic Film and Thin Sheeting by a Single-Tear Method,” ASTM D3763 “Standard Test Method for High Speed Puncture Properties of Plastics Using Load and Displacement Sensors,” each of which are hereby incorporated, in their entirety, by reference thereto.

TABLE 3

| | | | Tensile Strength (psi) | | Elongation at Break | | Young's Mod. (psi) | |
|---|---|---|---|---|---|---|---|---|
| Film | % Scrap | Thickness | ASTM D882 | | (%) ASTM D882 | | ASTM D882 | |
| Code | material | (mil) | LD | TD | LD | TD | LD | TD |
| Film 1 | 29 | 1.9 | 3530 | 2790 | 430 | 600 | 45100 | 54200 |
| Film 2 | 53 | 2.1 | 3390 | 2210 | 410 | 9.4 | 68400 | 63700 |
| Film 3 | 85 | 2.1 | 3680 | 2180 | 330 | 8.9 | 83500 | 80600 |
| Film 4 | 82 | 2.2 | 3040 | 2200 | 310 | 10 | 76800 | 77100 |
| Film 5 | control | 1.8 | 2920 | 2410 | 370 | 580 | 28700 | 35800 |

As shown in Table 3, the Films 1-4 exhibited improved tensile strength and Young's modulus as compared to the control film (Film 5).

TABLE 4

| | | Tear Propagation | | | | | | Instrumented Impact | |
|---|---|---|---|---|---|---|---|---|---|
| | | | | Energy to Break | | Tear Resistance | | Max Load | EtoB |
| | | Max Load (g) | | (g-in) | | Max Load (g) | | (N) | (J) |
| Film | % Scrap | ASTM D1938 | | ASTM D1938 | | ASTM D1938 | | ASTM | ASTM |
| Code | material | LD | TD | LD | TD | LD | TD | D3763 | D3763 |
| Film 1 | 29 | 586 | 455 | 1010 | 916 | 530 | 570 | 17.32 | 0.22 |
| Film 2 | 53 | 298 | 560 | 389 | 942 | 398 | 715 | 8.76 | 0.02 |
| Film 3 | 85 | 32.9 | 238 | 53.4 | 167 | 424 | 734 | 10.04 | 0.09 |
| Film 4 | 82 | 55.1 | 303 | 80.3 | 221 | 394 | 672 | 10.99 | 0.03 |
| Film 5 | Control | 377 | 395 | 484 | 776 | 351 | 504 | 15.24 | 0.14 |
| | (0%) | | | | | | | | |

As shown in Table 4, adjusting the amount of scrap material has an effect on the physical properties.

TABLE 5

| | | |
|---|---|---|
| OTR | Melt | Optics |

| Film Code | (cc/m2- day-atm) | Index | Clarity | Haze |
|---|---|---|---|---|
| Film 1 | 2825 | 0.77 | 1.6 | 19.7 |
| Film 2 | 1790 | 0.77 | 0.7 | 38.7 |
| Film 3 | 1570 | | 0.2 | 91.45 |
| Film 4 | 1610 | | 0.1 | 88.5 |
| Film 5 | 4675 | | 36.2 | 8.6 |

As shown in Table 5, scrap concentration has an impact on the optical properties of the film.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### PARTS LIST

10 extruders
11 polyamide
12 head
14 tubing
16 cooling ring
18 pinch rolls
20 irradiation vault
22 shielding
24 iron core transformer accelerator
26 rolls
28 tubing
30 windup roll
32 irradiated tubing tape coil
34 unwind roll
36 unwind tubing tape coil
38 guide roll
40 hot water bath tank
42 hot water
44 tubular tape
46 nip rolls
46 pinch rolls
48 bubble
50 film tube
52 nip rolls
54 parallel rollers
56 guide roll
58 wind-up roll
60 idler roll
62 bag
64 film
66 open top
68 bottom
70 end-seal
72 packaged meat product
74 packaged product
76 clips
78 casing film
80 inside surface
81 seals
82 outside surface
84 heat seal
86 inside surface
88 butt-seal tape
90 outside surface
92 inside surface
94 seal
139 extruder
210 end-seal bag
212 film
214 open top
216 end-seal
220 side-seal bag
222 open top
224 side seal
226 side seal
230 pouch
232 open top
234 side seal
236 side seal
238 end seal
530 extruder
531 die
531 annular die
532 screen pack
533 breaker plate
534 heaters
535 mandrel
536 air ring
537 bubble
538 guide rolls
539 nip rolls
540 treater bar
541 idler rolls
542 dancer roll
543 film tubing
544 roll
545 winder

1. A multi-layer film structure comprising:
a. at least one heat seal layer having a seal initiation temperature of less than any of the following temperatures: 220° C., 210° C., 200° C., 190° C., 180° C., 170° C., 160° C., 150° C., 140° C. or 130° C.;
i. the at least one heat seal layer having a calculated composite melt index of at least 3.0, 2.0 or 1.0 g/10 min @190° C. and 2.16 kg measured in accordance with ASTM D1238;
b. at least one reclaim layer comprising:
i. a blend of a polyolefin and at least one heat resistant polymer selected from the group consisting of polyamide, ethylene vinyl alcohol, polypropylene, polyester, and blends thereof;
ii. the at least one heat resistant polymer comprising at least 7.0, 7.5, 8.0, 8.5, 9.0, 9.5 or 10 wt % the total weight of the reclaim layer;
iii. at least 0.5 wt % of a compatibilizer;
iv. at least 0.05 wt % of an antioxidant; and
v. the at least one reclaim layer having a calculated composite melt index of less than 1.0, or 0.5 g/10 min @190° C. and 2.16 kg measured in accordance with ASTM D1238;
wherein the multi-layer film structure has a total scrap content of at least 25 wt % based on the total weight of the multi-layer film.

2. The multi-layer film structure of claim 1, wherein the at least one heat seal layer comprises at least 90 wt % of polyolefin selected from the group consisting of high density polyethylene, linear low density polyethylene, medium density polyethylene, low density polyethylene, very low density polyethylene, ethylene/alpha-olefin copolymer having a density less than 0.92 g/cc, homogeneous ethylene/alpha-olefin copolymer, and polypropylene.

3. The multi-layer film structure of claim 2, wherein the at least one heat seal layer has a calculated composite melt index of from 2 to 7 g/10 min @190° C. and 2.16 kg measured in accordance with ASTM D1238.

4. The multi-layer film structure of claim 1 wherein at least one reclaim layer has a seal initiation temperature of at least any of the following temperatures: 250° C., 240° C., 230° C., 220° C., 210° C., 200° C., 190° C., 180° C., 170° C., 160° C., 150° C., 140° C., 130° C. and 120° C. and has a seal initiation temperature at least 10° C., 20° C., 30° C., 40° C., 50° C., 60° C., 70° C., 80° C., 90° C., or 100° C. higher than the seal initiation temperature of the at least one heat seal layer.

5. (canceled)

6. The multi-layer film structure of claim 1 wherein the reclaim layer further comprises between 0.5-20 wt % antioxidant masterbatch selected from the group consisting of: 2,6-di(t-butyl)4-methyl-phenol(BHT), 2,2″-methylene-bis(6-t-butyl-p-cresol); phosphites, such as, triphenylphosphite, tris-(nonylphenyl)phosphite; and thiols, such as, dilaurylthiodipropionate; pentaerythritol tetrakis(3-(3,5-di-tert-butyl-4-hydroxyphenyl)propionate); and octadecyl 3-(3,5-di-tert-butyl-4-hydroxyphenyl)propionate.

7. (canceled)

8. (canceled)

9. The multi-layer film structure of claim 1 wherein the at least one heat resistant polymer comprising between 8 and 90 wt %, between 8 and 80 wt %, between 8 and 70 wt %, between 8 and 60 wt %, or between 8 and 50 wt % the total weight of the reclaim layer.

10. The multi-layer film structure of claim 1 wherein reclaim layer comprises at least 8%, 9%, 10%, 10%, 11%, 12%, 13%, 14%, 15%, 16%, 17%, 18%, 19% or 20% polyamide selected from the group consisting of polyamide 6, polyamide 69, polyamide 610, polyamide 612, polyamide 11, polyamide 12, polyamide 6/12, polyamide 6/66, polyamide 66/610, amorphous (6I/6T) and blends thereof.

11. (canceled)

12. (canceled)

13. The multi-layer film structure of claim 1 wherein reclaim layer comprises at least 4%, 5%, 6%, 7%, 8%, 9% or 10% ethylene vinyl alcohol.

14. The multi-layer film structure of any of claim 1 wherein the at least one reclaim layer has a calculated composite melt index of 0.0 g/10 min @190° C. and 2.16 kg measured in accordance with ASTM D1238

15. The multi-layer film structure of claim 1 wherein the multi-layer film structure has a tensile strength at break of at least 1400, 1500, 1600, 1700 or 1800 in the traverse direction measured in accordance with ASTM D882.

16. The multi-layer film structure of claim 1 wherein the multi-layer film structure has a tensile strength at break of at least 5400, 5600, 5800, 6000 or 6200 in the machine direction measured in accordance with ASTM D882.

17. (canceled)

18. (canceled)

19. (canceled)

20. The multi-layer film structure of claim 16 wherein the heat seal layer has a total polyolefin content of from 90 to 99 wt % based on the total composition of the heat seal layer.

21. The multi-layer film structure of any of claim 1 wherein the at least one reclaim layer comprising a blend of polyethylene and at least two distinct heat resistant polymers selected from the group consisting of polyamide, ethylene vinyl alcohol, polypropylene, polyester, and blends thereof.

22. (canceled)

23. (canceled)

24. (canceled)

25. The multi-layer film structure of any of claim 1 wherein the compatibilizer is present in the reclaim layer in amount from 0.5 to 10 wt % selected from an ethylene/acrylic acid copolymer or an ethylene/acrylic acid copolymer.

26. (canceled)

27. (canceled)

28. The multi-layer film structure of claim 1 wherein the at least one reclaim layer has a seal initiation temperature less than any of the following temperatures: 300° C., 290° C., 280° C., 270° C., 260° C., and 250° C.

29. (canceled)

30. (canceled)

31. (canceled)

32. The multi-layer structure of claim 1 wherein the film has a total polyolefin content of from 70 to 99 wt % based on total film weight.

33. (canceled)

34. The multi-layer structure of any claim 1 wherein the film has a total polyamide content of from 1 to 20 wt % based on total film weight.

35. The multi-layer structure of any claim 1 wherein the film has a scrap content of at least 50 wt % based on total film weight.

36. A packaging article comprising:
a first multi-layer film structure comprising:
a. at least one heat seal layer having a seal initiation temperature of less than any of the following temperatures: 220° C., 210° C., 200° C., 190° C., 180° C., 170° C., 160° C., 150° C., 140° C. or 130° C.;
i. the at least one heat seal layer having a calculated composite melt index of at least 3.0, 2.0 or 1.0 g/10 min @190° C. and 2.16 kg measured in accordance with ASTM D1238;
b. at least one reclaim layer comprising:
i. a blend of a polyolefin and at least one heat resistant polymer selected from the group consisting of polyamide, ethylene vinyl alcohol, polypropylene, polyester, and blends thereof;
ii. the at least one heat resistant polymer comprising at least 7.0, 7.5, 8.0, 8.5, 9.0, 9.5 or 10 wt % the total weight of the reclaim layer;
iii. at least 0.5 wt % of a compatibilizer;
iv. at least 0.05 wt % of an antioxidant; and
v. the at least one reclaim layer having a calculated composite melt index of less than 1.0, or 0.5 g/10 min @190° C. and 2.16 kg measured in accordance with ASTM D1238;
wherein the multi-layer film structure has a total scrap content of at least 25 wt % based on the total weight of the multi-layer film;
the heat seal layer of the first multi-layer film structure being bonded to itself or a second film.

37.-45. (canceled)

46. Method of making a packaging article comprising the steps of:
a. providing a multilayer film comprising:
a first multi-layer film structure comprising:
i. at least one heat seal layer having a seal initiation temperature of less than any of the following temperatures: 220° C., 210° C., 200° C., 190° C., 180° C., 170° C., 160° C., 150° C., 140° C. or 130° C.;
ii. the at least one heat seal layer having a calculated composite melt index of at least 3.0, 2.0 or 1.0 g/10 min @190° C. and 2.16 kg measured in accordance with ASTM D1238;
iii. at least one reclaim layer comprising:
A. a blend of a polyolefin and at least one heat resistant polymer selected from the group consisting of polyamide, ethylene vinyl alcohol, polypropylene, polyester, and blends thereof;
B. the at least one heat resistant polymer comprising at least 7.0, 7.5, 8.0, 8.5, 9.0, 9.5 or 10 wt % the total weight of the reclaim layer;
C. at least 0.5 wt % of a compatibilizer;
D. at least 0.05 wt % of an antioxidant; and
E. the at least one reclaim layer having a calculated composite melt index of less than 1.0, or 0.5 g/10 min @190° C. and 2.16 kg measured in accordance with ASTM D1238;
wherein the multi-layer film structure has a total scrap content of at least 25 wt % based on the total weight of the multi-layer film;
b. bonding the multilayer film to itself or a second film;
c. forming a packaging article according;
d. filing the packaging article with a food product; and
e. sealing the packaging article to seal the food product within the bonded multilayer film(s).
